(19) United States
(12) Patent Application Publication
(10) Pub. No.: US 2021/0137037 A1
(43) Pub. Date: May 13, 2021

(54) HYDROPONIC GROWTH SYSTEM AND ASSEMBLY

(71) Applicant: Fork Farms Holdings, LLC, Appleton, WI (US)

(72) Inventor: Alexander R. Tyink, Appleton, WI (US)

(73) Assignee: Fork Farms Holdings, LLC, Appleton, WI (US)

(21) Appl. No.: 16/681,092

(22) Filed: Nov. 12, 2019

(51) Int. Cl. A01G 31/02; A01G 7/04

(52) U.S. Cl. CPC A01G 31/02; A01G 7/045

(57) ABSTRACT

The present application discloses a hydroponic system including a planting block or structure including a plurality of plant units coupled to a water source to provide water to root chambers of the plurality of plant units. The system includes a lighting structure movably supported along a rail to adjust a location of the lighting structure relative to the planting block or structure. As described, the lighting structure includes a plurality of lighting elements or fixtures disposed in a flexible duct connectable to HVAC equipment or blower to supply air flow to dissipate heat from the lighting elements or fixtures. In illustrated embodiments, the plant units are coupled to a blower or fan through a duct to actively control humidity in the root chambers.

### FIELD OF THE INVENTION

The present relates to a hydroponic growth system for growing plants and in particular, a hydroponic growth system including a planting block or structure.

### BACKGROUND

Farming in controlled environments removes many links from the supply chain, which reduces costs and barriers when compared to conventional agriculture and offers fresher product to consumers. One type of plant growth method that has gained in popularity is hydroponic plant growth. Hydroponics is a subset of hydroculture, which is a method of growing plants without soil by using mineral nutrient solutions in a water solvent. The water solvent or mixture can include enzyme, bacterial, fungal inoculants as well as other mineral nutrients. Terrestrial plants may be grown with only their roots exposed to the mineral solution, or the roots may be supported by an inert medium, such as perlite or gravel.

The nutrients used in hydroponic systems can come from an array of different sources and can include, but are not limited to, byproduct from fish waste, duck manure, or purchased chemical fertilizers. Successful implementation of hydroponic plant growth systems is dependent on cost effective grow practices and resource utilization. This background provides a general discussion of hydroponics system and challenges and demands for enhancing efficiency and yield.

### SUMMARY

The present application relates to a hydroponic assembly including a planting structure comprising a plurality of plant units having a root chamber and a plurality of planting wells. In an illustrated embodiment, the assembly includes a lighting structure movably supported along a rail or first support structure to adjust a position of the lighting structure relative to the planting structure. An irrigation system includes one or more feeder lines to supply water to the plant units. Water is discharged from root chambers of the plant units via a gutter and is collected via a sump tank or reservoir. In illustrated embodiments the planting structure includes a plurality of wheels to adjust the position of the planting structure within a grow room or enclosure. Thus, illustrative embodiments of the hydroponic assembly include a movable lighting structure and/or movable planting structure to optimize spacing and lighting.

In illustrative embodiments, the present application includes planting and lighting structures for hydroponically growing plants. The lighting structure as described includes a plurality of lighting elements or fixtures disposed within an elongate duct. The elongate duct is coupled to HVAC equipment or blowers to provide air flow to cool the lighting elements or fixtures. In another embodiment, the assembly includes a duct having a passageway coupled to root chambers of the plant units and to blowers and HVAC equipment to provide air flow to the root chambers. Air flow is released from the root chambers through vents and condensation is released from the root chambers through an outlet openings and gutter coupled to the outlet openings. Thus, illustrative embodiments of the assembly include a HVAC lighting structure and/or root chamber HVAC structure to provide air flow to the root chambers of the planting structure.

In illustrative embodiments, the planting structure includes a plurality of plant unit including at least one removable plant panel having a plurality of planting wells. The at least one removable panel is coupled to a body structure of the plant unit through a tongue and groove connection to slideably connect the at least one panel to the body structure. In an illustrative embodiment, the body structure is a U-shaped body structure having a groove or channel along an elongate height and the panel is slideably connected to the U-shaped body structure through groove or channel. Other slideable connections are contemplated to connect plant panels to the U-shaped body structure of the plant units.

The removable plant panels include sealing features to limit leakage from the root chambers. Depending upon the height of the plant unit, the structure includes multiple plant panels slideably connectable to the body structure. The multiple panels are connected via connection features to form a sealed root chamber. The plant panel of the present application includes flow features to enhance fluid flow through the root chamber of the plant unit. Flow features include v-shaped channels below the planting wells and perimeter features to direct fluid flow. The above discussion describes embodiments of the present application and is not intended to be limiting and other applications and embodiments may be implemented as described in the detailed description of illustrative embodiments and as will be appreciated by those skilled in the art. Illustrative embodiments of the invention can use one or more of the inventive features or structures disclosed in the present application.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures in which:

FIG. 1 schematically illustrates an embodiment of a hydroponic growth system or assembly of the present application.

FIG. 2A schematically illustrates an embodiment of hydroponic planting and lighting structures of the present application.

FIG. 2B illustrates an embodiment of a carriage of a lighting structure movable along a rail to adjust a position of the lighting structure.

FIG. 2C is a side elevational view of an embodiment of the planting and lighting structures of the present application.

FIG. 2D schematically illustrates an embodiment of the planting structure including wheels or rollers movable along a track or rail.

FIG. 2E is a detailed view of an embodiment of the lighting structure of the present application.

FIG. 3 is a front elevational view of the planting and lighting structures connected to an irrigation system to supply a water mixture to a planting block.

FIG. 4A is an exploded view of a plant unit of a planting structure and a gutter, according to an embodiment of the present application.

FIG. 4B illustrates an embodiment of the plant unit of the present application.

FIG. 4C is a detailed illustration of portion 4C of FIG. 4B.

FIG. 4D is a cross-sectional view generally taken along line 4D-4D of FIG. 4C.

FIG. 4E is a cross-sectional view of an alternate embodiment of the plant unit.

FIG. 4F is a cross-sectional view of another embodiment of the plant unit without a diffusion plate.

FIG. 4G schematically illustrates connection of the feed lines to a planting block or structure and supply line.

FIGS. 5A-5B schematically illustrate a vent structure for a root chamber operable between a closed position shown in FIG. 5A and an opened position shown in FIG. 5B.

FIG. 5C schematically illustrates an embodiment of a planting block or structure including a duct coupled to root chambers of plant units of the planting block or structure and to HVAC equipment to provide air flow to the root chambers.

FIG. 6A is a detailed illustration of portion 6A of FIG. 4B.

FIG. 6B illustrates multiple plant panels coupled to a body structure of a plant unit through a tongue and groove connection in accordance with an illustrative embodiment.

FIG. 6C is a detailed view of portion 6C of FIG. 6B.

FIGS. 6D-6E illustrate an interface structure between adjacent plant panels.

FIG. 7A illustrates a front side of an embodiment of a plant panel having a plurality of planting wells and trellis.

FIG. 7B illustrates a back side of the plant panel illustrated in FIG. 7A.

FIGS. 7C-7D are top view illustrations of embodiments of a plant panel with an edge strip disposed in a groove or channel of a body structure of a plant unit.

FIG. 7E illustrates a planting well of a plant panel of the present application.

FIG. 7F illustrates an embodiment of a grow medium plug in the planting well of FIG. 7E.

FIG. 7G illustrates a clone collar, in accordance with one embodiment.

FIG. 7H illustrates a planting well with the clone collar in the planting well.

FIG. 7I illustrates a clone collar in a planting well behind a grow medium plug.

### DETAILED DESCRIPTION OF ILLUSTRATIVE EMBODIMENTS

The present application relates to a hydroponic growth system. The hydroponic growth system may be referred to as a flower room system or a hydroponic library. The hydroponic growth system may be used for plant growth including flowering plant growth and vegetative plant growth. The hydroponic growth system may be used for industrial growth of leafy vegetables, flowering plants, medicinal herbs, cooking herbs, beans, root vegetables, grain crops, and commercial vine crops (for example, the bush varieties of the vine crops). For example, such plants may include lettuce, spinach, kale, arugula, tomatoes, cucumbers, soy beans, strawberries, cannabis, and corn as well as other plants. Specific descriptions of any type of plant growth is not intended to be limiting as assemblies of the present application can be used for any plant growth type.

In various embodiments, the hydroponic growth system may be used for single cola development. Single cola development, or “sea of green technique,” is used to produce many small plants as opposed to a small number of large plants. The underlying principle is that growing many smaller plants as opposed to fewer larger plants reduces vegetative growth time and makes it easier to completely fill a space and maximize light efficiency. This generally can provide a yield advantage. Additionally, producing only colas, the largest top-most bud of a plant, makes processing the product simpler as it removes the need to process “popcorn” buds or low weight buds, where the processing time is high.

The hydroponic growth system may be configured for increased utility of space within a large area such as a warehouse. The area where the plants are grown using the hydroponic growth system may be referred to as a grow room. In various embodiments, multiple grow rooms may be provided within an enclosure such as a warehouse. In illustrated embodiments, grow rooms are themselves enclosed spaces with a service deck, or false roof over them or may be a stand alone room or a room within a room. Mechanical and other components of the hydroponic growth system may be supported on the service deck to implement the growth systems described in the present application.

FIG. 1 schematically illustrates an embodiment of a hydroponic growth system 100 of the present application including hydroponic planting structures 102, a lighting structure 104 and an irrigation system 106. As shown, the lighting structure 104 is positioned to provide grow light to the plants (illustrated schematically) on the planting structures 102. The irrigation system 106 supplies a water and nutrient mixture or solution to the planting structures 102 through feeder lines 110 coupled to the hydroponic planting structures 102. The water mixture or solution is provided to the feeder lines 110 through an irrigation supply line 112 coupled to a source or tank 114. The water mixture from feeder lines 110 empties into return line 116 that discharges to the source or tank 114. As schematically shown, source or tank 114 is coupled to a water supply 118 and nutrient or additive supply 120. Illustrative nutrient additives include natural nutrients and chemical fertilizers. In one embodiment, tank 114 is a 450 gallon tank which is coupled to drain 122 to release overflow.

Multiple feeder lines 110 are coupled to supply line 112 in parallel to provide the water mixture to multiple planting structures 102. The planting and lighting structures 102, 104 are housed in a grow room or other enclosure 125. Illustrative enclosures include warehouses, buildings or rooms within a building. Embodiments of the grow room or enclosure include an HVAC system 126 and a dehumidification system 128 (illustrated schematically) to control the temperature and humidity in the grow room or enclosure 125. The HVAC system 126 includes heating and air conditioning equipment, including for example, fans compressor, heat exchanger, HVAC sock or vents. The fans or vents may be strategically positioned to create a breeze for temperature and humidity control. In the illustrated embodiment, two planting structures 102 and a light structure 104 are shown, however, application is not limited to a growth system 100 with two planting structures 102 and a lighting structure 104 and the system can include any number of planting structures and lighting structures and any number of feeder and supply lines.

The HVAC/dehumidification equipment and lighting structures 104 may be operated independently or may be controlled through a central controller 130. As shown, the controller receives feedback from sensor(s)/sensor panel 131 and uses the feedback to control the HVAC equipment 126, dehumidification equipment 128 and lighting structures 104. In particular, feedback from an HVAC temperature sensor is used to increase or decrease room temperature through control of the HVAC equipment and feedback from sensor(s) is used to control dehumidification equipment 128.

The controller 130 includes one or more hardware and software components programmed through a control panel 132 (illustrated schematically). The control panel 132 incudes a graphical user interface (GUI) or other user interface to input control parameters for the HVAC and dehumidification equipment. Additionally in the embodiment shown, the system includes HVAC equipment 133, such as a blower or fan coupled to the lighting structure(s) 104 and vent 134 as will be described herein. The HVAC and dehumidification equipment may be housed in an equipment substructure outside the grow room, or on a service deck or other structure in the grow room based upon space efficiency and layout. In an illustrative embodiment, the grow room or enclosure 125 includes an emergency air evacuation system, a water chiller system, a fertigation system, a CO₂ system, and/or a dry room as will be described herein.

FIG. 2A illustrates an embodiment of the planting and lighting structures 102, 104 of the present application. As shown, the planting structures 102 includes a planting structure support 135 and a planting block 136. The planting block 136 is coupled to the planting structure support 135 in an upright position for growing plants. As shown, the planting structure support 135 includes a base 140, a plurality of upright supports 142 coupled to the base 140 and a plurality of support rails 144 coupled to the upright supports 142. In the embodiment shown, the base 140 is formed of a platform structure, however application is not limited to the embodiment shown.

The planting block 136 is connected to rails 144 to support the planting block 136 in the upright position. The support 135 (upright supports 142 and rails 144) may be formed of any suitable material such as metal, plastic, or stainless steel. In some embodiments the material may be powder coated, painted with UV resistant paints, or otherwise treated to be FDA compliant. In some embodiments, the planting blocks 136 are attached to the rails 144 of the planting structure support 135 via screws or other fasteners. While the planting structure 102 in FIG. 2A illustrates a separate support 135 and planting block 136, in illustrative embodiments, the support 135 of the planting structure 102 is integrally formed with the planting block 136.

In the embodiment shown in FIG. 2A, the system includes multiple lighting structures 104 movably coupled to rails 150 as illustrated by arrow 152 to adjust a position of the lighting structures 104 for use. Illustratively rails 150 are fixed to the building or enclosure 125. The lighting structures 104 as shown include a plurality of lighting tracks 154 coupled to a support fixture 156. The support fixture 156 is movably coupled to the rails 150 through carriages 158 (illustrated diagrammatically) that move along rails 150 to slideably connect the lighting tracks 154 to the rails 150. Thus, as illustrated by arrow 152, the support fixture 156 is moved via carriages 158 to adjust the position of the lighting tracks 154 for use.

As shown, multiple lighting tracks 154 are coupled to the support fixtures 156 at spaced height elevations to provide lighting along a height of the planting block 136. In the embodiment shown, support fixtures 156 are coupled to multiple rails 150 through multiple carriages 158 spaced along the length of the lighting track 154. In alternate embodiments the height elevation of the lighting tracks 154 can be adjusted on the support fixture 156 to adjust the height elevations of the lighting tracks 154 relative to the planting block 136.

FIG. 2B schematically illustrates an embodiment of a carriage 158 movable along rails 150 via rollers 160 to adjust the position of the lighting structures 104 or the support fixtures 156 for the lighting tracks 154. The position of the lighting tracks 154 is adjusted relative to the planting blocks 136 to increase or decrease light intensity for the plants by adjusting the distance d between the lighting structures 104 and the planting block 136 as shown in FIG. 2C. For example, leafy greens, may be spaced approximately 13 inches from lighting tracks 154. In contrast, the lighting tracks 154 are spaced approximately 2-4 feet away from a planting block 136 for growing cannabis.

The distance d can be adjusted manually or through an electronic actuating mechanism (not shown) configured to move the carriages 158 along rails 150 in response to user input to the control panel 132. In the embodiment shown, the planting structure 102 or planting structure support 135 is supported on the ground or floor of the grow room or enclosure 125 as shown in FIG. 2C.

In an illustrative embodiment shown in FIG. 2D, the planting structure 102 includes a plurality of wheels 162 to adjust the position of the planting structures 102 in the grow room for space and growth optimization. In the embodiment shown in FIG. 2D, the plurality of roller wheels 162 are coupled to the planting structure 102 and movable along a track 163 along a ground or floor of the grow room 125. As shown, the roller wheels 162 are moved along track 163 to adjust the position of the planting structure 102 through operation of a control mechanism 164 to bidirectionally adjust the position of the planting structure 102 through a drive linkages 166, 167 (illustrated schematically). Input to the control mechanism 164 moves the drive linkage 166 which moves drive linkage 167 coupled to wheel(s) 162 to linearly move the planting structure 102 along track 163. Illustrative mobile assemblies for providing movably planting structures 102 are available from Spacesaver Corporation of Fort Atkinson, Wis. to form the movable or adjustable planting structures 102 of the present application.

In an alternate embodiment not shown, the roller wheels 162 and track 163 can be located overhead and application is not limited to the particular embodiment shown. Application is not limited to a mechanical control mechanism 164 as shown and the wheels 162 can be rotated electronically through an electronic control device.

FIG. 2E illustrates an embodiment of the lighting tracks 154 of the lighting structures 104 shown in FIG. 2A. The lighting tracks 154 includes a plurality of spaced lighting fixtures 170 (only one shown in FIG. 2E) including a bulb 180 or other lighting element. The bulb or other light element 180 is encased in a glass tube 182 to form the lighting fixture 170. In other embodiments, the lighting element or fixture includes LED elements or a strip of LED elements. The lighting fixtures 170 used depend upon the crop being grown. Some crops, such as cannabis, are best suited for high light. For high light applications, high intensity discharge bulbs such as metal halide bulbs may be used. Other crops, such as leafy vegetables, are better suited for LED light bulbs or elements. The lighting fixtures 170 are enclosed in a passageway of duct 185 to form an HVAC lighting structure. As shown, the duct 185 includes transparent or clear portions 186 and flexible non-transparent portions 188 interspaced along the duct 185. In an illustrated embodiment, non-transparent portions are formed of a flexible tubing. The lighting fixtures 170 are aligned with the clear or transparent portions 186 to provide the light to the growing plants.

Lights contribute significant heat to the grow room or enclosure 125. As schematically shown, the HVAC equipment 133, for example, blowers, fans or air condition unit is coupled to the flexible duct 185 to supply cool air to dissipate heat generated by the light fixtures or elements 180. The HVAC equipment 133 is operably controlled in response to temperature and other sensors 131 to control temperature parameters in the lighting duct 185 in response to user input as previously described.

As shown, the lighting fixtures 170 are coupled to a power control or dimmer circuitry 190 to adjust power to the lighting fixtures 170 to control light intensity and heat output during the plant growth cycle. For example, the power can be lowered from a wattage of 1000 to 600 watts depending upon the application and/or the distance d of the lighting track 154 (or lighting fixtures 170) from the plants can be adjusted as previously described. In another embodiment, the wattage range is 150-400 watts. When plants are younger, it may be useful to have the light power at 50%.

Thus, as described, light intensity can be adjusted by adjusting the power of the lighting fixtures 170 and/or by adjusting distance d of the planting blocks 136 or structure 102 from the lighting fixtures 170 as shown in FIG. 2C. When power of the lighting fixtures 170 is kept the same but the distance d from the lighting tracks 154 is increased, a more uniform spread of light over the canopy or planting block 136 is created but the plants are not getting as much light over time. The uniform spread of light may provide a consistent growth rate. In contrast, the closer the lighting track 154 to the planting block 136, the more light the plants get but the less consistency there is of the light over the canopy.

As shown in FIG. 3, the lighting ducts 185 are coupled to vent(s) 134 to release hot air to the outside. Alternately hot air is recycled through air return 192 to make use of the hot air for heating. The HVAC system or equipment 133 uses outside or return air to provide cool air to the lighting ducts 185 to cool the lighting fixtures 170 or lighting elements 180. Release of air to vent(s) 134 is controlled via a flow gate or valve (not shown). In some embodiments, vent or ventilation flues (not shown) are provided along the length of the duct 185.

In some situations, it may be useful to increase the light intensity by decreasing the distance d of the lighting tracks 154 from the planting blocks 136 or structures and increasing the power of the lighting fixtures 170. This can reduce the number of hours the lights are on and can increase energy efficiency. The balance of light power and distance D of the lighting tracks 154 to the plants (and thus consistency of light over the canopy) is based on the specific needs of the application. For budding flowers, one balance may be desirable whereas at other times of growth, a different balance may be desirable. In some situations, the quality of the plant may matter less and the energy efficiency may matter more. The hydroponic growth system provides control tools for customizing the lighting on an industrial scale. When plants are younger, it may be desirable to have less light. This may be done by adjusting either or both of the distance of the planting blocks 136 or structure 102 from the lighting fixtures 170 or tracks 154 and the intensity of the light.

As previously described, the water mixture is supplied to the planting blocks 136 via feeder lines 110. The water mixture from the planting blocks 136 is discharged to a gutter 194. Gutter 194 empties into a reservoir or sump tank 200 and is recirculated to the water source 114 via a sump pump 202 as shown. In the embodiment shown, water from the reservoir 200 goes through a filtration system 204 prior to return to tank or source 114. In some embodiments, the sump tank may be used as the main tank or source 114. In other situations, where both a main tank 114 and a sump tank 200 are provided, primary water usage may shift to the sump tank and nutrients provided to the sump tank 200 during different phases.

Water may then be pumped from the sump tank directly to the supply or feeder lines 112, 110. Float valves (not shown) may be provided in tanks 114, 200 to control water levels. For example, in response to a low water level, the float valve operates to pump from the sump tank 200 to the main tank 114.

Water may then be pumped from the sump tank directly to the supply or feeder lines 112, 110. Float valves (not shown) may be provided in tanks 114, 200 to control water levels. For example, in response to a low water level, the float valve operates to pump from the sump tank 200 to the main tank 114.

FIG. 4A is an exploded view showing the plant unit 210 and gutter 194 of an illustrative embodiment of the planting structure 102. As shown, the plant unit 210 includes an elongate height extending from a top of the plant unit 210 to a bottom of the plant unit 210. As shown in detail in FIGS. 4B and 4C, the plant unit 210 includes a hollow enclosure 212 surrounding an inner passage forming a root chamber 214. The hollow enclosure 212 includes a plurality of planting wells 216 opened to the inner passage or root chamber 214. Water flows into the inner passage or the root chamber 214 through an opened top end or inlet of the enclosure 212 and is discharged into the gutter 194 through an outlet or opening at the bottom of the hollow enclosure 212.

In the illustrated embodiment, the hollow enclosure 212 is formed of an elongate generally U-shaped body structure 218 and a plant panel 220 removably coupled to opposed sides of the U-shaped body structure 218 to form a rectangular shaped plant unit 210 or rectangular shaped enclosure 212 of plant unit 210. As shown, the plurality of planting wells 216 are formed on the plant panel 220. While a particular shaped plant unit 210 is shown, application is not limited to the rectangular shape shown. The plant units 210 or enclosures 212 can be formed from concrete, plastic or other material as will be appreciated by those skilled in the art. Adjacent plant units 210 of a planting block 136 can be integrally formed such that walls of the body structure 218 or enclosure 212 are shared to form the adjacent plant units 210 in an illustrative embodiment.

The depth of the root chamber 214, or the distance from the plant panels 220 or planting wells 216 to a back of the root chamber 214, may be customized for the type of crop being grown and application is not limited to a specific depth. In particular, the depth of the root chamber 214 influences humidity in the root chamber 214. Different types of crops need different humidity levels and thus the depth of the root chamber 214 is selected based upon the required humidity level of the plant. For example, a suitable depth for cannabis is approximately 6 inches. Leafy vegetables generally need a higher humidity level and thus the root chamber 214 is sized for higher humidity.

The plant unit 210 as shown in FIG. 4C includes a top cover 230 sized to fit over the opened end of the hollow enclosure 212. The top cap 230 helps to keep water inside the root chamber 214 by preventing the water from splashing out of the root chamber 214. In the embodiment shown in FIG. 4C, the plant unit 210 also includes a diffusion plate 232 below the top cover 230. The diffusion plate 232 includes a plurality of flow openings 234 formed through plate 232 to disperse water flow to the passage or root chamber 214 for controlled fluid flow. In the embodiment shown, the diffusion plate 232 is a removable inset that can be removed for cleaning. The diffusion plate 232 operates to direct the water to flow vertically along a height of the root chamber 214.

The diffusion plate 232 may have a flat bottom surface, a slanted bottom surface, or a v-shaped bottom surface. The diffusion plate 232 slows water pressure from the feeder lines 110 and redirects the water so that it falls generally vertically down the root chamber 214. The openings 234 on the diffusion plates 232 may be designed to direct the water to areas of the root chamber 214 far enough from the stem base of the plant to minimize root rot. Thus, design and placement of openings 234 depends upon the type of plants. In some applications it may be desirable to have more water flow proximate the planting wells 216 and in other situations it may be more desirable to have more water flow central to the root chamber 214.

As shown in FIG. 4C, the diffusion plate includes a lip 240 along front and back edges of the diffusion plate and a side rail 242 extending along sides of the diffusion plate 232. An overflow mechanism may be built into the diffusion plate so that if high water volumes are required, excess water can be directed to flow out of the back side of the diffusion plate 232. The overflow mechanism may be one or more openings (not shown) provided through the lip 240 along the back edge of the diffusion plate 232. The openings direct water into the back of the root chamber 214.

As shown in FIGS. 4C-4D, plant unit 210 includes a cradle structure at the top of the hollow enclosure 212. The cradle structure includes curved cutouts 250 along opposed sides of the hollow enclosure 212 sized to support the feeder line 110 adjacent to the opened end or inlet of the inner passage or root chamber 214. Cover 230 and diffusion plate 232 similarly include cutouts to fit over the feeder line 110 when the cover is secured to the top of the hollow enclosure 212. In particular as shown, the cut outs are half circles cut into the side rails 242 of diffusion plate 232 and top cap 230 to accommodate the feeder line 110 along the top of the plant unit 210 and root chamber 214 as shown in FIG. 4D. Gaskets or other suitable device (not shown), may be provided in the half circles to provide a fluid seal to limit leakage. As shown the diffusion plate 232 is supported along a top of the enclosure via rails 242 which abut and rest on the top edge of the enclosure 212 or body structure 218.

As shown in FIG. 4D, the feeder line 110 is an elongate tubular structure having a plurality of flow openings 252 extending through the tubular structure of the feeder line 110 to supply water mixture to the root chamber 214. The flow openings 252 may be uniformly sized or have different sizes. The hole size controls the gallons of water per minute as well as system and water pressure. The hole pattern and placement can be designed based upon requirements of specific system and plants. For example, for leafy greens it is desirable to have the water near the plant panel 220 or the planting wells 216 whereas another location may be desirable for strawberries.

In another embodiment shown in FIG. 4E, the diffusion plant 232 is supported on a rim 254 in root chamber 214. In FIG. 4F, the plant unit 210 does not include a diffusion plate and water flows directly from the feeder line 110 to the inner passage or root chamber 212. In the embodiment shown in FIG. 4F, flow openings 252 in the feeder line 110 are orientated upwardly in the direction of the top cap 230 to provide a generally atomized spray. A surface of the top cap 230 can be curved to control the direction of water or solution. While a separate top cap 230 is shown for each plant unit 210, the planting structures 102 can have an integral top cap sized and configured to cover a plurality of plant units 210 or planting block 136. Alternatively, individual tops caps are connected via a rod or other connection to remove and replace the tops caps 230 for the block of plant units 210 in unison.

The feeder lines 110 are formed of a flexible tubular structure to allow the feed lines to bend to align with openings 256 along the supply line 112 as shown in FIG. 4G. In particular, depending upon placement of the planting structure or block 136 it may be necessary to bend the feeder lines 110 to connect to the supply line 112. In an illustrated embodiment the feeder lines 110 may comprise flexible PVC pipe to allow the pipe to bend to align with openings 256 along the supply line 112.

In illustrated embodiments, heat and humidity are released from the root chamber 214 through a ventilation flue or vent 257. The vent 257 is located at the top of each root chamber 214 to provide convention air flow to release humidity and reduce temperature. Vents 257 can be formed via gaps or openings in the enclosure or top cover 230. In particular a vent opening 258 can be formed by a gap between the top cap 230 and the root chamber 214. For example, the depth of the root chamber 212 from the plant panel 220 to the back of the root chamber 214 may be approximately ½ inch longer than the depth of the top cap 230 to form the vent opening or gap 258. In an illustrated embodiment, the vent opening 258 can be formed through top cover 230 to release heat and humidity from the root chamber 214 to ambient or the grow room.

Vent openings 258 can include a vent closure operable between an opened position and a closed position to open and close the vent 257. When the vent is open, convection air will flow out of the vent, thereby reducing heat and humidity in the root chamber. When the vent is closed, it will contain the heat and humidity. For example, in an illustrated embodiment wing nuts form a vent closure to close the gap or vent opening 258 in the top cap 230. In the embodiment shown in FIGS. 5B-5C the vent closure is a disc-shaped structure 259 with openings that rotates between a closed position shown in FIG. 5A and an opened position shown in FIG. 5B.

FIG. 5C schematically illustrates a root chamber HVAC system to actively control temperature and humidity in the root chamber 214. As shown, the planting block 136 includes an HVAC duct 260 extending along the bottom of the hollow enclosures 212 or root chambers 214 of plant units 210. The duct 260 is coupled to HVAC equipment 133, including for example, an air conditioning unit or fan and coupled to the multiple root chambers 214 of the planting block 136 to provide air flow through the root chambers 214 of the planting block 136. Air from the HVAC duct 260 is pushed through the root chambers 214 and is vented through the vent openings 258 at the top of the plant units 210 or on the covers 230. In an alternate embodiment as also schematically shown in FIG. 5C, the gutter 194 forms the HVAC duct which is coupled to the HVAC fan or blowers 133. Cool air is conveyed along the gutter 194 above the water line and flows into the root chambers 214. The cool air reduces the temperature in the root chambers 214 so that the humid air forms water droplets which are collected in the gutter 194.

As previously described, the plant panels 220 are removably connectable to the body structure 218 to form the root chambers 214 as shown in FIGS. 6A-6B. In the illustrated embodiment shown the plant panels 220 are slideably and removably connectable to opposed sides of an opened face of the body structure 218 through tongue 265 and groove 266 features on the body structure 218 and plant panels 220 as shown in FIGS. 6B and 6C. In the illustrated embodiment groove or channel 266 is formed along opposed sides of an opened front face of the U-shaped body structure 218 as shown in FIG. 6A and the tongue 265 is formed of the side edges of the plant panel 220. The plant panels 220 are connected to the U-shaped body structure 218 to form a rectangular shaped plant unit 210. Illustratively the plant panels 220 are formed of a white colored panel to provide optimum reflectivity and energy efficiency.

As shown in FIG. 6A the plant unit 210 or enclosure 212 includes multiple plant panels to form the hollow enclosure 212 of the plant unit 210. The multiple plant panels 220 are interconnected through stepped edge features 270 that overlap to form a fluid tight seal as shown in FIGS. 6D-6E. Tabs 272 or other locking features as shown in FIG. 6B are provided to lock the multiple plant panels 220 in place. In some embodiments, the plant unit 210 or enclosure 212 is sized to accommodate approximately 12 vertical feet of plant panels 220. Application is not limited to the stepped edge features 270 to form a fluid tight seal and other sealing arrangements may be utilized.

As shown in FIG. 7A, the plant panels 220 include rows of planting wells 216. The planting wells 216 are cylindrical or oval shaped protrusions having a passage 280 therethrough opened to the root chamber 214. The protrusion and passages 280 are sized for insertion of grow medium plugs or clone collars. In particular, the protrusions and passages 280 are sized to provide a snug friction fit for the plugs or clone collars. In some embodiments the planting wells 216 may be between approximately 1-inch diameter and approximately 3-inch diameter. The planting wells may be integrally formed with the plant panel or comprise a separate structure that is attached to a hole provided through the plant panel 220.

The illustrated plant panel 220 shown in FIG. 7A also include trellis holes 282. The trellis holes 282 similarly comprise a cylindrical or oval shaped protrusion having a passage sized to accept a trellis stake (not shown). A trellis stake may thus be used for supporting plant growth by using trellising ties to tie the plant to the trellis stake. Trellis holes 282 may be provided in applications where it is useful to support a growing plant. In other applications, such as when growing leafy greens, trellis holes may not be provided.

FIG. 7B illustrates a back side of the plant panel 220 shown in FIG. 7A, in accordance with one embodiment. As shown, the back side of the plant panel 220 faces inwardly towards the root chamber 214. A back surface of the back side of the plant panel 220 includes flow features for channeling water flow. In one embodiment, the flow features comprise a rim 290 along a top of the back surface. The rim 290 as shown may be a jagged rim structure to direct flow away from the back surface toward the plant roots. The back side also includes channeling features 292 located beneath each planting well 216 to direct water away from the plant panel 220 after it has traveled through the plant roots.

In the embodiment shown, the channeling feature 292 is a V shape structure which may be particularly suited for crops that need significant water contact, such as leafy greens. The V shaped structure pulls water droplets back to a center line beneath the planting wells 216. This facilitates directing root growth along the V line such that the roots develop in a generally straight line and layer on top of each other. At the bottom of the root chamber 214, the root stack tends to be very thick while it tends to be thinner at the top. By facilitating root growth such that they stack on each other, water seeps through the roots more consistently.

The back side of the plant panel 220 may be designed to reduce water from going around the side of the panel and out of the front. As shown, edge strips 294 may be provided along the vertical edges of the back side of the plant panel 220 to reduce any water seepage to a front face of the panel 220 to keep the front surface dry and reduce the likelihood of mold and pathogens from growing. The edge strips 294 prevent water from going around the panel 220 along the grooves or channel 266. As shown in FIG. 7C, in one embodiment, the groove or channel 266 is sized so that the edge strips 294 on the back side of the panel 229 fit into and extend along the groove or channel 266 while in another embodiment shown in FIG. 7D, the edge strip 294 is spaced from the edge of the panel 220 to provide a seal along the channel or groove 266.

In the embodiment shown in FIG. 7E the inner passage 280 of the planting wells 216 includes an O-ring or stop ring 300 formed of a compressible material. The O-ring 300 may be molded into the planting well 216 or may be a separate piece adhered within passage 280 of the planting well 216. The O-ring 300 may be provided at any position along passage 280 of the planting well 216 to accommodate the desired amount of grow medium.

FIG. 7F illustrates a grow medium plug 302 sized for insertion into the passage 280 of the planting well 216 in accordance with one embodiment. The grow medium plug 302 may also be referred to as a rooting plug or a seeding plug. The grow medium plug 302 is a plug comprising a growth medium that may be placed in the planting well 216. Any type of grow medium for facilitating plant growth may be used. For example, the grow medium plug may comprise fabricated blocks of cocoa, peat moss, rock wool, coconut core, or organic core. The O-ring 300 assists to retain the grow medium plug 302 in the planting wells 216. The grow medium plug 302 may be made into a custom size and shape. In other embodiments, no grow medium is used.

FIG. 7G illustrates a clone collar 305, in accordance with one embodiment. The clone collar 305 may be formed of any suitable material. In one embodiment, the clone collar 305 is formed of a reusable rubber material. The clone collar 305 is a piece that can be positioned in the planting well 216 to hold a plant clone in the correct position in the plant panel 220. As shown, the clone collar 305 may have a slit 306 through its radius to allow the collar 305 to hug or be wrapped around the plant clone. If a clone collar 305 is used, the collar 305 can be placed in front of the grow medium plug 302 as shown in FIG. 7H. Alternatively as shown in FIG. 7I, the grow medium plug 302 is placed in front of the clone collar 305.

Thus as described, in illustrative embodiments, the hydroponic growth system utilizes three HVAC systems including an environmental temperature control system (also referred to as an environmental HVAC system), a lighting heat evacuation system (also referred to as a lighting HVAC system), and a root chamber HVAC system to control temperature and humidity in the planting structures or plant units. In some embodiments, the HVAC system may be a closed recirculating system such that it conserves CO₂ supplementation. The closed system provides energy savings with heat, reduces contaminants, and substantially prevents pests and contaminants from entering the grow room. The closed system pulls air out of the grow room itself and cools it before reintroducing it to the grow room.

An emergency evacuation system may be built into the grow room or enclosure 125. If temperatures rise above a level that can harm plants, a blower may be turned on to evacuate air out of the grow room to quickly reduce temperatures. The blower may be positioned on the service deck and blow air through the HVAC into the grow room. An additional blower may be provided on the other side of the grow room with the fan blower reversed to pull air out of the grow room. Providing two blowers, one pushing air in and one pushing air out, doubles the speed of CFM exchange. A carbon filter may be provided on the unit pulling air from the grow room to reduce the scent of the air.

The controller for the emergency evacuation system may be separate from the controller(s) 130 for the other HVAC and control systems. In some embodiments, the emergency evacuation system may have a thermostat or sensors and a set point above which activates the emergency evacuation system. In some embodiments, the set point may be around approximately 100-110° F. If the temperature exceeds the set point, the blowers are turned on. The blowers then may remain on until the temperature drops below a minimum threshold. The minimum threshold may be, for example, approximately 80° F. A separate thermostat or sensor may be provided in the grow room for controlling the other HVAC systems. Accordingly, two or more duplicated independent systems may be provided for controlling temperature in the grow room.

In some embodiments, airflow may be used to trim roots. In certain points in the hydroponic growth system, particularly near the gutter 194, it may be useful to trim the roots to ease cleaning after harvest. If the humidity level drops below a certain point in the root chamber 214 or if water ceases to flow past the roots, the roots will dry. Air trimming occurs when roots sufficiently dry out. Accordingly, a very dry environment may be provided in a location where air trimming may be desirable, such at the base of the root chamber. In particular, the flow of air through the duct 260 or gutter 194 at the base of the root chamber may be used to lower the humidity in that area to facilitate root triming. In one embodiment, this may be achieved by having sufficient distance between the root chamber and the bottom gutter 194 to allow air trimming by a forced air system in the gutter 194 to occur before roots hit the gutter 194.

It may be useful to pump CO₂ into the hydroponic growth system. In general, the CO₂ would be released on the leaf side of the plants. Release of CO₂ may be done by pumping CO₂ into the one of the HVAC systems and distributing the CO₂ via the ventilation flues. Alternatively, dedicated CO₂ lines may be positioned in key places around the grow room. In one embodiment, a CO₂ input line may be connected to the environmental heat evacuation system and CO₂ may be pumped in with the air conditioning. In another embodiment, a CO₂ line may be provided near the top of the room. The CO₂ line may comprise one or more small hoses that have many holes and function as soaker hoses. Because CO₂ is heavier than air, the CO₂ will naturally sink over time. The rate of release may be customized to optimize CO₂ levels in the grow room.

In embodiments where the plant panels 220 or units 210 extend very high, multiple spaced feeder lines 110 may be provided at different height elevations. In one embodiment, the plant panels or units extend approximately 12 feet up and a single feeder line 110 is provided as illustrated in FIG. 3. In an embodiment where the plant panels 220 or units extend, for example, 40 feet up, 3 or 4 spaced feeder lines 110 may be provided at spaced elevations to assure that irrigation is consistent along the entire height of the root chambers 214. In such embodiments, the feeder lines 110 extend through access holes (not shown) through the side walls of the enclosures 212 or plant units 210.

Netting (not shown) may be used to hold plants up as they get heavy. Netting may be placed vertically in front of the plant panels of the planting blocks 136 or structures. The netting may be attached to structural support bars (not shown) of the planting blocks 136 or planting structure support 135 so that plants grow into the netting. A plant misting system may be provided for misting water on the plants. In such an embodiment, the plant misting system can be installed on the planting structures 102 or blocks 136 to apply foliar feeds, pesticides, insecticides, or other liquids that may be desirable for application to the plants.

A fertigation system may be provided in some embodiments. A fertigation system is an automatic nutrient/pH/water temperature adjustment system. It automatically controls the nutrient and pH levels in the main tank by measuring the levels and making adjustments. In some embodiments, a separate dry room may be provided in conjunction with the grow room. The dry room may be used for drying plants such as cannabis and spices. A separate thermostat and dehumidifier may be provided in the dry room. In general, the dry room may have limited lighting because it may not be desirable for light to be on the plants during drying.

The hydroponic growth system may be provided with redundancies. For example, 2 main pumps and 2 sump pumps may be provided in each tank, as well as 2 float valves in each tank. Two orifices may be provided in each lateral irrigation line (in case one clogs). This reduces any risk of plants dying and environmental setbacks depending upon capacity.

The hydroponic growth system described may be used with plant clones. An initial step in growing plants with the hydroponic growth system is to create clones. There are generally two ways to create clones. One is to grow a mother plant, take cuttings from the mother plant, and root the cuttings to grow smaller plants. The cuttings are dipped in a root growth hormone and planted in a grow medium plug or clone collar. When the clone roots, it is placed into the planting well, where it flowers.

The other method of creating clones is to plant tissue culture. Cells are taken from a plant and multiplied in a test tube. The cells are put in a gelling medium with hormones that excite different parts of the plant's development. Plantlets are put in jars and developed into clones. The clone or seeds are planted in the planting wells with a collar provided for maintaining the plant in place in the planting well. The clones or seeds are planted in the planting well at a desired density, for example every planting well 216 or every other planting well 216.

The intensity of the light, the movement of the lights, gallons per hour of the irrigation system, pH of the water, concentration of nutrients, types of nutrients, and humidity in the room may be selected based on the type of crop and the time in the plant growth cycle. As the plants grow, the light intensity and on cycle may be varied, the HVAC settings may be changed, and the irrigation may be changed through controller inputs as previously described. These are adjusted based on plant health and metabolism to optimize growth.

As the plants grow, they grow into netting or along a trellising stake (not shown), if provided. In some embodiments, the plants may grow without a capture mechanism. When using a netting, to harvest, the stems may be cut so that the plants are entrained in the netting. The netting may be rolled up and then moved into a dry room. A single netting may be used for each plant panel or for multiple plant panels. Many plants thus may be moved in one netting. The plants may be dried on the netting to optimize space in the dry room. Using a dehumidifier, the plants are cold cured without increasing the temperature of the grow room. Trichomes are affected by heat so minimizing increases in temperature leads to higher quality dried plants.

The ease of harvest of plants from the hydroponic growth system is notable. In a normal commercial plant growing setting, plants are planted and harvested from a horizontal system. This involves kneeling, bending, etc. The vertical hydroponic growth system reduces wear and tear on the body of workers. The panels 220 move seamlessly up and down in the channeling of the root chamber formed via groove 266 along an elongate length of body structure 218. Gravity allows for the panels 220 to drop easily. As a result, it is easy to access plants that are very high by removing each of the plant panels beneath those plants. It is not necessary for a worker to use a ladder. Although a particular U-shaped body structure 218 is shown, application is not limited to the particular shape shown or a particular plant unit shape.

In the foregoing description various embodiments of the invention have been presented for the purpose of illustration and description. They are not intended to be exhaustive or to limit the invention to the precise form disclosed. Obvious modifications or variations are possible in light of the above teachings as will be appreciated by those skilled in the art. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

What is claimed is:

1. A hydroponic assembly comprising
lighting structure including at least one lighting element movably coupled to a first support structure to adjust a position of the at least one lighting element of the lighting structure;
a planting structure including a plurality of plant units having an inner passage forming a root chamber and at least one inlet opening and at least one outlet opening for fluid flow through the root chamber and the plurality of plant units including at least one planting well opened to the root chamber; and
at least one feeder line connectable to an irrigation source and the plurality of plant units to provide fluid flow to the root chambers through the inlet openings of the plurality of plant units.

2. The assembly of claim 1 wherein the assembly includes a plurality of wheels coupled to the planting structure to adjust a location of the planting structure.

3. The assembly of claim 2 wherein the plurality of wheels are movable along a track to adjust the location of the planting structure for use.

4. The assembly of claim 3 and comprising a drive mechanism operable through an input device to rotate at least one of the plurality of wheels to move the wheels along the track to adjust the location of planting structure.

5. The assembly of claim 1 wherein the at least one feeder line is formed of flexible tubing including a plurality of openings through an outer wall of the flexible tubing and the flexible tubing is coupled to each of the plurality of plant units of the planting structure in series.

6. The assembly of claim 1 wherein the plurality of plant units include a cradle structure including contoured supports sized to support the at least one feeder line along the top of the plurality of plant units.

7. The assembly of claim 1 wherein the plurality of plant units include at least one plant panel removably coupled to a body structure to form an enclosure for the root chamber and the at least one plant panel including the at least one planting well.

8. The assembly of claim 7 wherein the at least one plant panel includes water flow features along a back side of the at least one plant panel.

9. The assembly of claim 1 wherein the plant units include at least one plant panel removably connected to a body structure through a tongue and groove connection to form an enclosure for the root chamber and the at least one plant panel includes the at least one planting well.

10. The assembly of claim 9 wherein the body structure is a U-shaped body structure having an opened face and the at least one plant panel is removably coupled to opposed sides of the opened face of the U shaped body structure to form a rectangular shaped plant unit and root chamber.

11. The assembly of claim 1 including a dispersion plate including a plurality of openings disposed in the root chambers of the plurality of plant units below the at least one feeder line to disperse fluid from the feeder line into the root chambers of the plurality of plant units.

12. The assembly of claim 1 and comprising a gutter coupled to the outlet openings of the plurality of plant units and comprising a blower or HVAC equipment coupled to the gutter to provide air flow to the root chambers of the plurality of plant units.

13. A hydroponic plant unit comprising:
an elongate body structure;
a plurality of plant panels slidably coupled to the elongate body structure through a tongue and groove connection to form an elongate enclosure and inner passage having at least one inlet opening and at least one outlet opening to form a root chamber for the plant unit and the plurality of plant panels including at least one planting well opened to the root chamber.

14. The hydroponic plant unit of claim 13 wherein the tongue is formed along perimeter edges of the plurality of plant panels and the groove is formed along the elongate length of the body structure.

15. The hydroponic plant unit of claim 13 wherein the elongate body structure is generally a U-shaped body structure to form a generally rectangular shaped plant unit and the plurality of plant panels are slideably coupled to opposed sides of the U-shaped body.

16. The hydroponic plant unit of claim 13 wherein the at least one planting well is formed on front sides of the plurality of plant panels and back sides of the plurality of plant panels include at least one V shaped flow feature below the at least one planting well.

17. A hydroponic assembly comprising:
a planting structure including a plurality of plant units having a root chamber and the root chamber having an inlet and an outlet and at least one planting well; and
a duct coupled to the plurality of plant units having a passageway opened to the root chambers of the plurality of plant units and connectable to a blower to provide air flow to the root chambers.

18. The assembly of claim 17 wherein the duct is formed via an elongate gutter coupled to each of the plurality of plant units at the outlet of the root chambers.

19. The hydroponic assembly of claim 17 and comprising a lighting structure including:
a lighting track including a plurality of spaced lighting elements supported within a duct and the duct is coupled to a blower or equipment to provide cool air flow to dissipate heat generated by the lighting elements.
